(19) United States
(12) Patent Application Publication
(10) Pub. No.: US 2019/0297046 A1
(43) Pub. Date: Sep. 26, 2019

(54) MULTI-LATERAL EMAIL ACCUMULATION PROCESSING

(71) Applicant: CA, Inc., New York, NY (US)

(72) Inventors: Steven L. Greenspan, Scotch Plains, NJ (US); George Derrick Watt, Kanata (CA); Michael J. Cohen, Flushing, NY (US)

(21) Appl. No.: 15/933,312

(22) Filed: Mar. 22, 2018

(51) Int. Cl. H04L 12/58

(52) U.S. Cl. CPC H04L 51/22

(57) ABSTRACT

Embodiments are disclosed for distributing email delivery processing. In some embodiments, an inactivity indicator associated with a user agent is detected. Based on the inactivity indicator, a delivery completion request is generated and sent to a first sending user agent from which a first email is received prior to detecting the inactivity indicator. The delivery completion request includes an identifier for the first email and one or more selectable delivery options including at least a delivery termination option. In response to a reply from the first sender user agent to the delivery completion request that includes selection of the delivery termination option, delivery of the first email to the first user agent is terminated.

### BACKGROUND

The disclosure generally relates to the field of data processing, and more particularly to implementing multi-lateral email accumulation processing.

Electronic messaging, such as via email, is the dominant mode of inter-personal and inter-entity communication. Substantial time and processing resources are expended by users traversing email messages within one or more email inboxes per user. Management tools such as spam filters are utilized by many email systems to reduce potentially substantial volumes of unwanted incoming messages, thereby preventing unnecessary expenditures of time by users to sort through valueless email messages.

Traversing received email messages can be particularly time-consuming and potentially wasteful during a period of email client inactivity, such as when an email client user is absent from a work email account for a considerable period. Most email systems include an out of office feature that enables users to configure an auto-reply to emails received during a specified out of office period. The out of office feature provides useful information to email senders but does not address the considerable burden posed to users when their email clients accumulate a large number of potentially unnecessary email messages during periods of user inactivity.

### BRIEF DESCRIPTION OF THE DRAWINGS

Embodiments of the disclosure may be better understood by referencing the accompanying drawings.

FIG. 1 is a block diagram depicting a messaging network including components for implementing distributed processing of message accumulation in accordance with some embodiments;

FIG. 2A is a block diagram illustrating a system for implementing multi-lateral control of message accumulation processing in accordance with some embodiments;

FIG. 2B depicts a displayed pending delivery request object that is generated and processed by components of the system depicted in FIG. 2A to control access to and processing of pending delivered emails in accordance with some embodiments;

FIG. 2C illustrates a displayed delivery completion request object that is generated and processed by components of the system depicted in FIG. 2A to control continued delivery of pending delivered messages in accordance with some embodiments;

FIG. 3 is a flow diagram depicting operations and functions performed by a message delivery control system in accordance with some embodiments;

FIG. 4 is a flow diagram illustrating operations and functions performed by a message delivery control system in accordance with some embodiments; and

FIG. 5 is a block diagram depicting an example computer system that may be utilized to control message delivery for accumulated messages in accordance with some embodiments.

### DESCRIPTION

The description that follows includes example systems, methods, techniques, and program flows that embody embodiments of the disclosure. However, it is understood that this disclosure may be practiced without these specific details. In other instances, well-known instruction instances, protocols, structures and techniques have not been shown in detail in order not to obfuscate the description.

### INTRODUCTION

Messaging systems and networks and such as email and text messaging systems includes subsystems and components for sending and receiving and storing messages. For example, an email system includes an email client (referred to herein as mail user agents, user agents, or email agents) that includes an inbox facility for storing or otherwise recording inbound emails addressed to the user account associated with the client. Most email systems implement a divided inbox facility comprising a remote inbox that is managed by an email server and a local inbox that may locally cache inbound emails retrieved from the server inbox. The potentially large number inbound emails received during a period of email client inactivity consume processing and storage resources as well as requiring considerable time and effort of the email client user to sort through the accumulated emails.

Overview

The disclosed methods and systems include operations, functions, and components for enabling distributed control of message delivery coinciding with periods of message client inactivity. In some embodiments, a pending delivery control system includes delivery management agent (DMA) components within a receiving message client for selecting message inactivity settings that may be utilized to configure a message handling agent within a message server. The message handling agent within the message server includes delivery management service (DMS) components configured to implement delivery control settings received from the message client. The DMS components are further configured to retrieve pending delivery instructions from sender email clients that originate the inbound emails. The DMS components implement, remove, and otherwise modify email access controls based, at least in part, on the retrieved pending delivery instructions.

### Example Illustrations

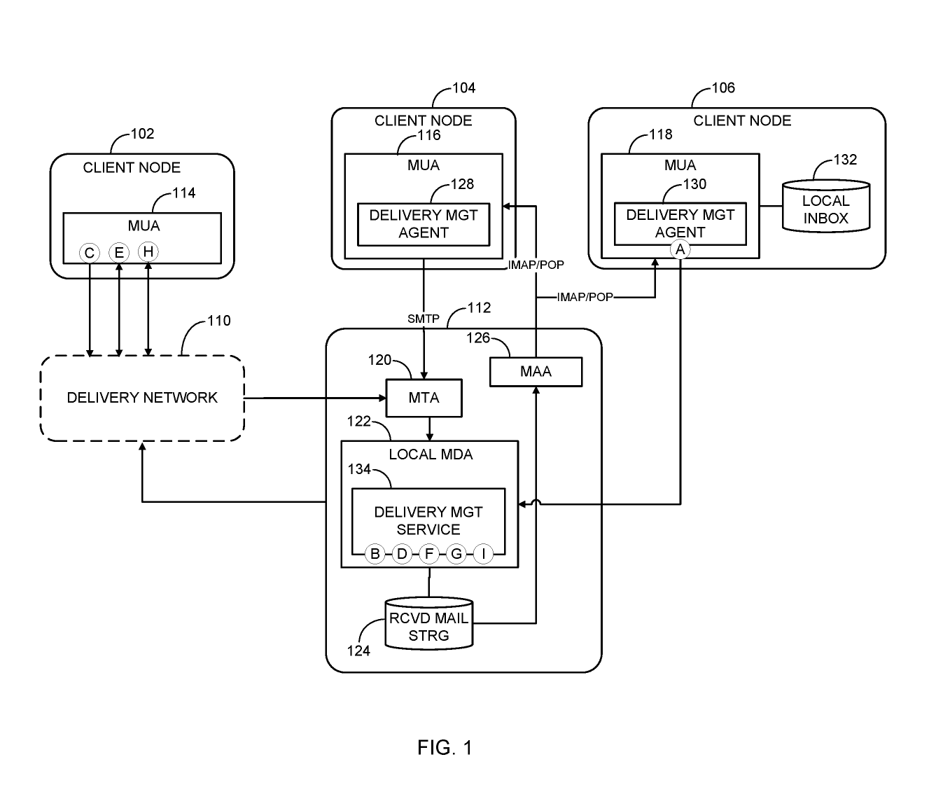

FIG. 1 is a block diagram depicting a messaging system including components for implementing distributed processing of message accumulation in accordance with some embodiments. While the depicted embodiment in FIG. 1 and others of the figures describe email systems and components, the operative and functional principles disclosed and claimed herein may be implemented by and applied to other networked electronic messaging systems such as text messaging systems. The depicted messaging system is an email system comprising networked nodes including client nodes 102, 104, and 106, and an email server node 112. Client nodes 104 and 106 are similarly configured and included in a same local email network that includes and is hosted by email server 112. Client nodes 104 and 106 include mail user agents (MUAs) 116 and 118, respectively, which are local clients of the local email network hosted by email server 112. As utilized herein, an MUA may also be referred to as an email agent. Client node 102 includes a MUA 114 that is communicatively coupled to the local email network via a delivery network 110.

For descriptive purposes, transactional operations and sequences of operations are described with respect to the depicted MUAs 114, 116, and 118, and email server 112 relating to an inactivity period for a receiving MUA. As utilized herein, a “receiving” user agent is a message agent, such as an email user agent, for which an inactivity indicator has been detected and for which operations and sequences of operations are performed to provide multi-lateral client control (i.e., control by sender as well as receiver user agents) of email messages (referred to herein alternately as emails) that are subject to accumulation during receiving user agent inactivity. In the following description, MUA 118 performs operations and functions as the receiving MUA, and MUAs 114 and 116 performs operations and functions as sender MUAs.

MUAs 116 and 118 include delivery management agents (DMAs) 128 and 130, respectively. Each of DMAs 128 and 130 are configured, using any combination of program logic and data, to select or otherwise input delivery control settings associated with periods of user inactivity. For example, DMAs 128 and 130 may comprise program instructions incorporated as part of the out of office feature of the corresponding MUA. Specifically, each of DMAs 128 and 130 may be an extension of an out of office component that generates displayable user interface (UI) object features for enabling delivery control operations to be performed during an enabled out of office period.

Email server 112 includes several components for facilitating transport of emails from sending MUAs to receiving MUAs. Included among the email deliver components are a mail transfer agent (MTA) 120 and a local mail delivery agent (MDA) 122. MTA 120 is an email server program component that enables transfer of emails from one network node (e.g., a forwarding email server within delivery network 110) to another (client node 106) by determining destination nodes and reformatting of email “envelope” address information.

MDAs within delivery network 110 (not expressly depicted) are referred to as transport or TCP MDAs and are configured to actually transport email messages to a next email server based on the MTA processing. MDA 122 is a so-called local MDA that is configured to store incoming emails within MUA inboxes (not expressly depicted in FIG. 1) the storage for which is provided by a mail storage database 124. Message handler program instructions in the form of a mail access agent (MAA) 126 are configured to respond to client requests for email access by retrieving the stored emails using, for example, the Internet Message Access Protocol (IMAP) protocol. MAA 126 may be a distinct component or may be incorporated within local MDA 122 in some embodiments.

MDA 122 includes a delivery management service (DMS) 134 for implementing a delivery control mode of operation associated with the control settings received from either of the DMAs. DMS 134 comprises one or more distinct program components for implementing multi-lateral email accumulation processing in part by distributing delivery pendency options and delivery completion options to sending MUAs.

FIG. 1 is annotated with a series of letters A-I. These letters represent stages of overall operation of the depicted embodiment. Although these stages are ordered for this example, the stages illustrate one example to aid in understanding this disclosure and should not be used to limit the claims. Subject matter falling within the scope of the claims can vary with respect to the order and some of the operations.

Implementing a given delivery control configuration may begin at stage A, with DMA 130 providing displayed UI options associated with an out of office configuration object. The displayed UI options include user-selectable options to enable a delivery control mode of operation to be implemented during a specified out of office period that is defined as the period between a specified start time point and a specified end time point. The displayed UI options may further include delivery pendency options and delivery completion options that are to be subsequently communicated by DMS 134 to sender MUAs as part of email delivery and distribution control. Based on input received from a UI input device, such as a pointer device or keyboard, the displayed options are saved as a configuration update message that is provided as input to local MDA 122 and DMS 134.

The configuration update message may include or be included in an auto-reply instruction that instructs MDA 122 to automatically send email replies in response to each email sent by sending MUAs such as MUAs 114 and 116 during the specified out of office period. At stage B, DMS 134 processes the configuration update message in association with the storage account information for MUA 118 to modify a delivery control record that specifies whether out of office operation is enabled and whether delivery control operation is enabled in association with out of office operation. DMS 134 modifies delivery pendency option fields and delivery completion options within the delivery control record based on the content of the configuration update message.

At stage C, MUA 114 begins user agent sending operation by generating and sending via delivery network 110 an email addressed to MUA 130. The email is processed by MTA 120 to confirm MUA 130 as the destination, and by MDA 122 for storage by email server 112. At stage D, DMS 134, in cooperation with MUA account components within MDA 122 and/or MAA 126 determines, based on a delivery control record for MUA 118, whether to generate and send an auto-reply message to sending MUA 114 in response to the received email. As part of or otherwise in association with determining whether to send the auto-reply message, such as by determining whether out of office operation is currently enabled, DMS 134 further determines whether delivery control operation is enabled based on the currently delivery control record for MUA 118.

In response to determining that delivery control operation is enabled in association with out of office auto-reply operation, DMS 134 and other components of MDA 122 implement a visibility control on the received email. In some embodiments, the visibility control comprises an access control on the received email that restricts access by MUA 118 to the email. In one embodiment, DMS 134 may implement the access control by storing the received email in a pending delivery folder that MUA 118 does not have direct and/or default access to. In further response to determining that delivery control operation is enabled in association with out of office auto-reply operation, DMS 134 in conjunction with other components of MDA 122 generates an auto-reply message that includes user selectable delivery pendency options and delivery completion options specified in the current deliver control record for MUA 118.

At stage E, MUA 114 receives the auto-reply message that includes a message section and one or more requested options for determining whether and how to continue delivery of the email addressed to MUA 118 and currently stored by email server 112. Input to one or more input selection options is received and recorded in the auto-reply message which is displayed in a MUA UI within MUA 114. Continuing with stage E, the auto-reply message containing the selected delivery pendency options is returned such as via a reply option or otherwise by MUA 114 to MDA 122 and DMS 134 via delivery network 110.

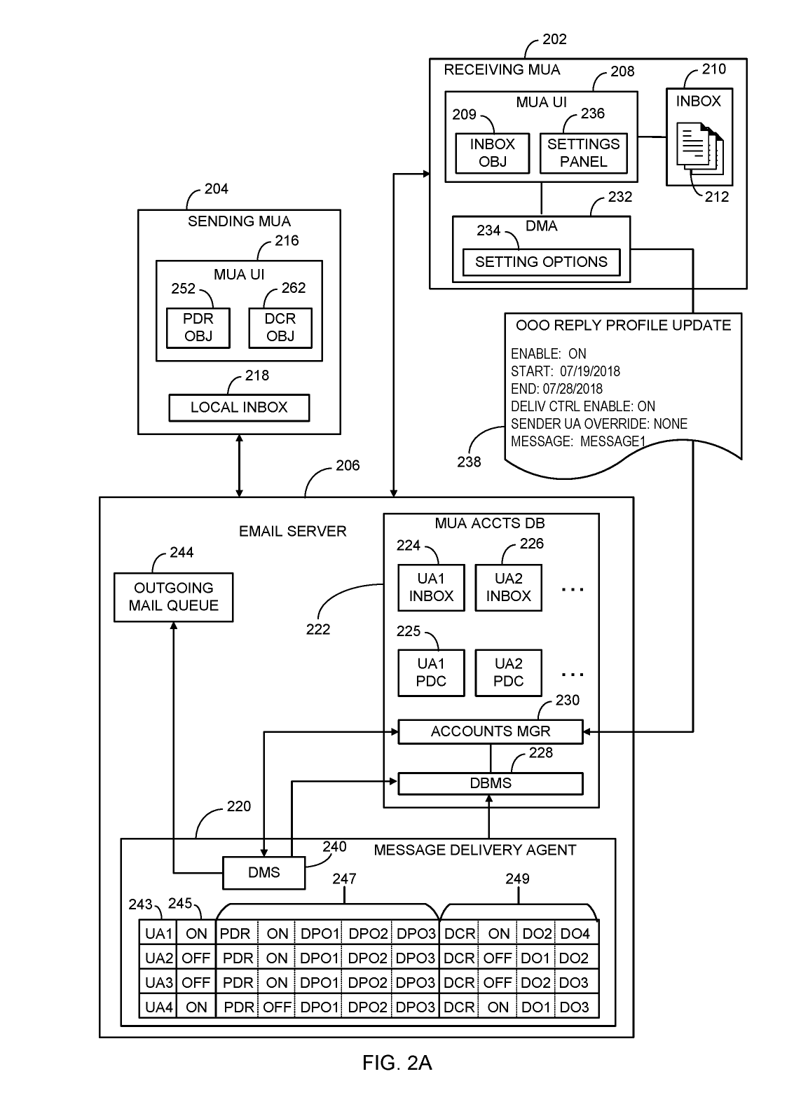

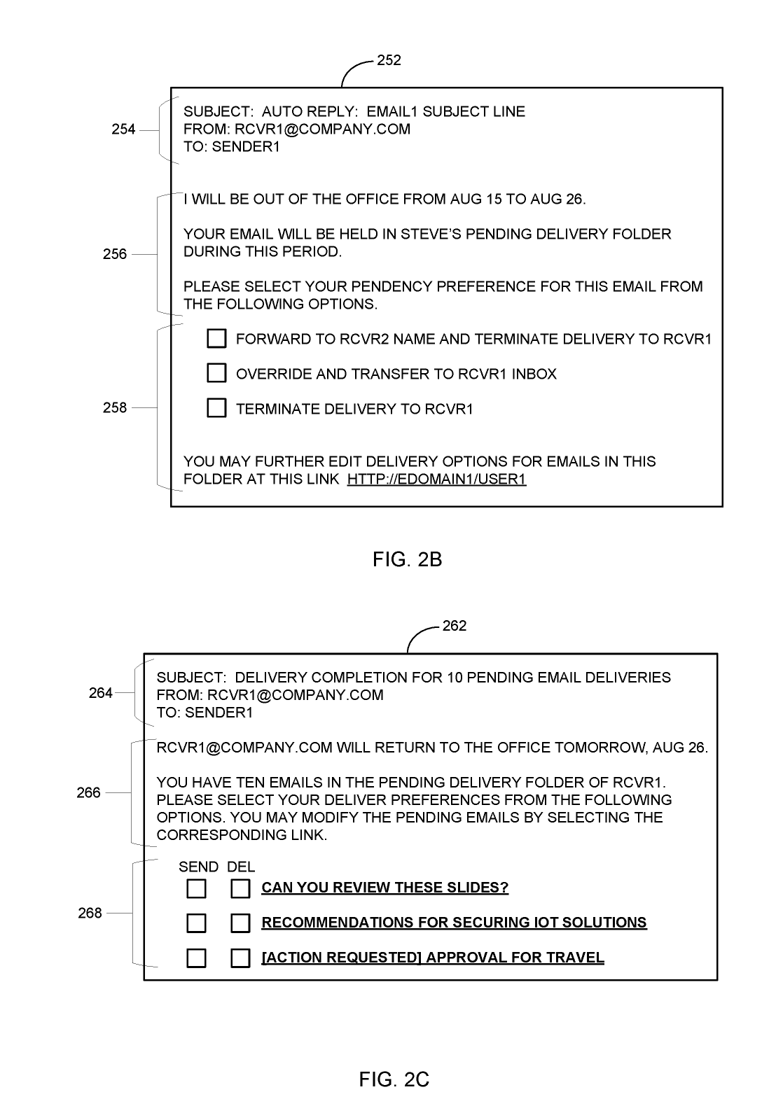

At stage F, DMS 134 reads and processes the selected delivery pendency options received within a reply message from MUA 114 and modifies the access control implemented on the received email at stage D based on the selection options. For example, in some embodiments, the delivery pendency options include at least an alternate delivery option which can be selected to forward the email to a user email address specified in the alternate delivery option. In response to selection of the alternate delivery option in the reply to the auto-reply message, DMS 134 terminates delivery of the email to MUA 118 and forwards the email to another MUA having the specified email address. Additional delivery pendency options that may be selected and processed by DMS 134 at state F are depicted and described with reference to FIGS. 2A and 2B.

At stage G, DMS 134 detects an inactivity indicator associated with MUA 118. Continuing with the example described at stages A-F, DMS 134 may detect the inactivity indicator by determining expiration of the inactivity period (e.g., detecting that the end time point of the inactivity period has lapsed/been reached). In some embodiments, DMS 134 may detect the inactivity indicator as a direct inactivity metric such as a period over which the received email has not been accessed from email server 112 by MUA 118 to be input into a local inbox 132 and/or opened as a displayed object within MUA 118. Whether the inactivity indicator is detected as a specified parameter or is measured as a metric of determined inactivity, DMS 134 responds by generating and sending a delivery completion request to MUA 114 at stage G that is based on the detected inactivity indicator. As depicted and described in further detail with reference to FIGS. 2A and 2C, the delivery completion request includes an identifier for the received email associated with one or more selectable delivery completion options including at least a delivery termination option.

MDA 122 sends the delivery completion request to MUA 114, which at stage H opens and processes the request to select and record selection of one or more of delivery completion options. At stage H, MUA 114 generates and sends a reply message to the delivery completion request message that includes the selected one or more delivery completion options. At stage I, DMS 134 in cooperation with other components of MDA 122 reads and processes the reply from MUA 114 to the delivery completion request. For example, in response to the reply including selection of the delivery termination option, DMS 134 terminates further delivery of and deletes the received email.

FIG. 2A is a block diagram illustrating a system for implementing multi-lateral control of message accumulation processing in accordance with some embodiments. The components and operations described with reference to FIG. 2A may be included in and performed by the components depicted and described with reference to FIG. 1. The depicted system comprises program code components represented in FIG. 1 as executing on processing nodes such as client or server nodes. As shown, the system includes a receiving MUA 202 communicatively coupled with a local email server 206. Receiving MUA 202 is communicatively coupled in terms of email transport with a sending MUA 204 via email server 206.

Sending MUA 204 and receiving MUA 202 comprise any combination of program code and data for composing, editing, sending, retrieving, and reading email messages. Sending MUA 204 includes a MUA UI 216, and receiving MUA 202 includes a MUA UI 208 each for displaying email objects representing folders including local inboxes. For example, within MUA UI 208, an inbox object 209 is displayed which represents the inbox email content 212 of a local inbox 210 that is generated and maintained by receiving MUA 202.

Receiving MUA 202 further includes a DMA 232 that is configured, using any combination of program code and data, to perform any of the operations described with reference to FIG. 1 as well as those described with reference to FIG. 2. In the depicted embodiment, DMA 232 includes instructions for displaying and entering settings options 234 for an out of office email handling feature. A settings panel object 236 is displayed within MUA UI 208 in response, for example, to selecting an out of office settings option. Settings panel object 236 includes multiple selectable options including an option to enable out of office auto-reply operation during a specified auto-reply period which may also be selected or otherwise entered into settings panel object 236.

Based on the selection options within settings panel object 236, DMA 232 records the selection options in a profile update message 238. As shown, profile update message 238 is an out of office profile update message including several fields such as an out of office enable field and a delivery control enable field both of which indicate ON. For the enabled out of office operation, profile update message 238 further includes a field specifying a start time point as a date of Jul. 19, 2018 which may default to 12:00 AM on the preceding day. The out of office period is defined by the start time point in combination with an end time point which is recorded as Jul. 28, 2018 in the end point field. Profile update message 238 further includes a sender MUA override field into which one or more sender MUA IDs can be entered to override delivery pendency for the identified MUAs. The profile update message 238 further includes a message field containing the message content input into setting panels 236 to be included in auto-replies during the out of office period.

Email server 206 is configured, using any combination of program code and data, to implement operations described with reference to FIG. 1 as well as operations described with reference to FIG. 2A. As shown, email server 206 includes an MDA 220 for processing received emails including storing incoming emails within a MUA accounts database 222. MUA accounts database 222 includes an accounts manager component 230 and a database management system (DBMS) 228 for generating, removing, and modifying records within accounts database 222. The database records are conceptually depicted as forming multiple remote MUA inboxes including UA1 INBOX 224 and UA2 INBOX 226. Remote inboxes 224 and 226 include emails that have not been uploaded or otherwise accessed by the respective MUAs such as receiving MUA 202.

In the depicted embodiment, profile update message 238 is processed by MDA 220 and accounts manager 230 to modify the delivery control records for MUA 202 accordingly. More specifically, MDA 220 includes a DMS 240 that is configured to process information in user agent accounts that determines settings for inactivity periods, such as out of the office periods, and also determines delivery control settings that may coincide with out of office operation. For example, DMS 240 may retrieve a delivery control record such as one of the depicted row-wise records within MDA 220 in response to a deliver control enable signal from DMA 232. Each of the row-wise records includes a user agent ID field 243 associated with a delivery control enable field 245 and delivery control settings fields. As shown, delivery control enable field 245 is associated with a pending delivery request (PDR) field 247 comprising multiple sub-fields and a delivery completion request (DRC) field 249 comprising multiple sub-fields.

DMS 240 includes instructions for processing delivery control records for MUAs in association with received emails that may be addressed to the MUAs such as receiving MUA 202. In response to receiving an email from sending MUA 204 having a destination address for MUA 202, DMS 240 retrieves and reads the current delivery control record for MUA 202 such as the first row-wise record among the depicted records. As illustrated, the first row-wise delivery control record specifies UA1 as the ID for receiving MUA 202. In association with the MUA ID, the record includes an ON value for the delivery control enable field 245, and ON values for the enable sub-fields within PDR and DCR fields 247 and 249. The PDR field 247 further includes three delivery pendency options, DPO1, DPO2, and DPO3, within the other three sub-fields. The DCR field 249 further includes two delivery completion options, DO1 and DO2, within the other two sub-fields. The delivery completion options may include delayed delivery options (e.g., delivery one or more emails after expiration of a specified delay period) as well as termination options.

Having read the delivery control record in association with the received email from sending MUA 204, DMS 240 implements an access control on the received email that restricts access by receiving MUA 202 to the received email within email server 206. For example, DMS 240 may record the received email within a pending delivery container 225 to which receiving MUA 202 does not have direct access. Having read the delivery control record in association with the received email from sending MUA 204, DMS 240 further generates and sends an auto-reply message in the form of a pending delivery request to sending MUA 204. The pending delivery request is received by sending MUA 204 within a local inbox 218 and displayed as a PDR object 252 within MUA UI 216. FIG. 2B depicts displayed PDR object 252 that is generated and processed by components of the system depicted in FIG. 2A to control access to and processing of pending delivered emails in accordance with some embodiments.

As shown, PDR object 252 includes a header section 254 comprising email ID information including subject text and further includes sender and receiver MUA ID codes. PDR object 252 further includes a message section 256 that explains the purpose of the auto-reply (e.g., out of office), and a selectable options section 258. Options section 258 includes three UI selectable options including an option to forward the email to another MUA, RCVR2, and terminate delivery to MUA 202. The second selectable option is an option to override the delivery control access control that has been implemented on the received email and the third is an option to terminate delivery to receiving MUA 202 with no forwarding. Options section 258 further includes a link, HTTP://EDOMAIN/USER1, which is selectable by the user to directly modify the received email or delivery options for the email.

DMS 240 receives a reply to the pending delivery request that includes the option(s) selected via UI inputs within MUA UI 216. DMS 240 is configured to modify the access control applied to the received email, such as moving the received email from pending delivery container 225 to MUA 202 remote inbox 224 in response to selection of the pendency override option.

In response to detecting expiration of the out of office period, DMS 240 generates and sends a delivery completion request via outgoing mail queue 244 to sending MUA 204. The delivery completion request may be displayed as a delivery completion request (DCR) object 262 within MUA UI 216. FIG. 2C depicts displayed DCR object 262 that is generated and processed by components of the system depicted in FIG. 2A to control whether and pending emails will be provided to local inbox 210 of receiving MUA 202 in accordance with some embodiments.

As shown, DCR object 262 includes a header section 264 that includes email ID information including subject text and further includes sender and receiver IDs. DCR object 262 further includes a message section 266 that describes the time at which the inactivity period ended or will soon end, and a selectable options section 268. Options section 268 includes UI selectable options corresponding to each of three emails sent by sending MUA 204 to receiving MUA 202 during the out of office period. Specifically, the UI options enable a user to select whether to continue delivery (SEND) or terminate delivery (DEL) of each of the three individual emails. Sender MUA 204 records the selected options in a reply message which is delivered to MDA 220 and DMS 240. In response to the reply message, DMS 240 either continues or terminates delivery depending on the selected option for each email.

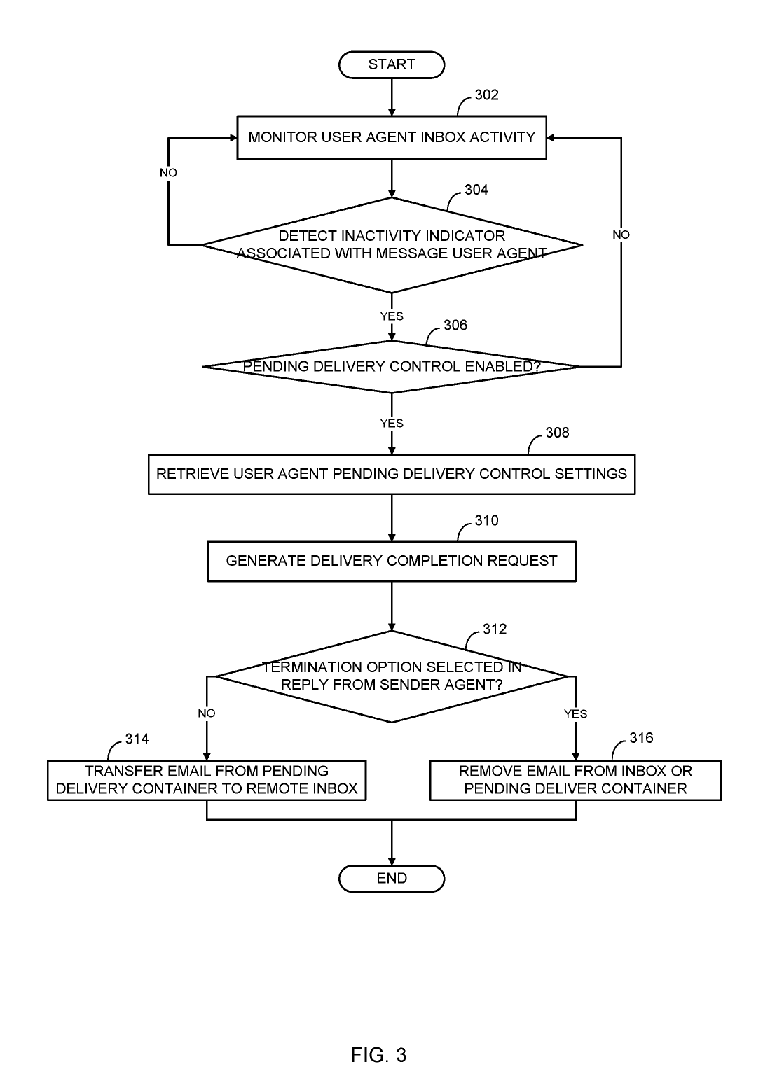

FIG. 3 is a flow diagram depicting operations and functions performed by a message delivery control system in accordance with some embodiments. The operations and functions depicted and described with reference to FIG. 3 may be performed by one or more of the devices and components depicted and described with reference to FIGS. 1 and 2. The process begins as shown at block 302 with an email server monitoring user agent inbox activity. For example, the email server may include a DMS that alone or in combination with MDA components monitors activity by a MUA with respect to emails addressed to the MUA that are stored in a remote inbox within an email server. For example, the DMS and MDA components may monitor retrieval by the receiving MUA of emails from the remote inbox into the local (i.e., within client system) inbox. In the same or other embodiments, the DMS and MDA components may monitor MUA local inbox activity such as opening the received email from the local or remote inbox within the MUA UI.

The email server includes a DMS that includes components for detecting an inactivity indicator associated with a receiving message user agent (block 304). For example, the DMS may determine that the period over which an email has not been accessed has exceeded a specified threshold. In another embodiment, the DMS may read a user agent record to determine expiration of an inactivity period such as an out of office period. In response to detecting the inactivity indicator, control passes to block 306 with a determination by the DMS of whether delivery control of incoming emails for the receiving user agent has been enabled. In response to determining that delivery control has been enabled in combination with detecting the inactivity indicator, the DMS retrieves pending delivery control settings for the receiving user agent at block 308.

Based on the delivery control settings, the DMS generates and sends to a sending user agent a delivery completion request that includes at least a delivery termination option associated with a received email (block 310). Control passes to block 312 with a determination by the DMS of whether or not the delivery termination option is selected in a reply message from the sending user agent in association with one or more emails. For each email for which a continue or send option is selected, or for which the delivery termination option is otherwise not selected in the reply, the DMS continues delivery by transferring the emails from a pending delivery container to a remote inbox for the receiving user agent (block 314). For each email for which the delivery termination option is selected in the reply, the DMS terminates delivery of the email (block 316).

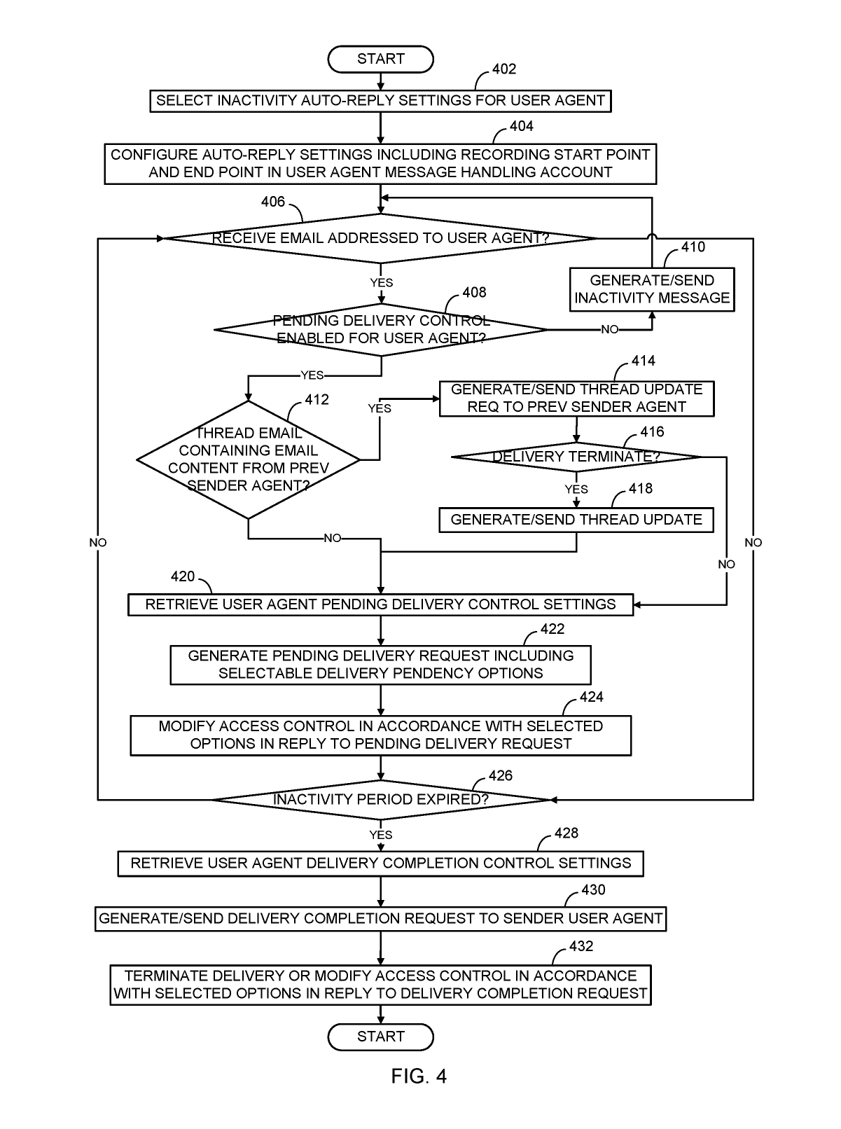

FIG. 4 is a flow diagram illustrating operations and functions performed by a message delivery control system in accordance with some embodiments. The operations and functions depicted and described with reference to FIG. 4 may be performed by one or more of the devices and components depicted and described with reference to FIGS. 1-3. The process begins as shown at block 402 with receiving user agent selection of inactivity auto-reply settings for the receiving user agent. Next, at block 404, the receiving user agent in cooperation with an email server account manager configure the auto-reply settings including start and end time points in an account record for the receiving user agent.

At block 406, a DMS, such as may be deployed within the email server receives emails from sending user agents during the specified inactivity period. In response to receiving an email from a sending user agent at block 406, the DMS determines at block 408 whether delivery control is currently enabled for the receiving user agent (i.e., the user agent to which the email is addressed as the final destination). If delivery control is determined not to be currently enabled, control passes to block 410 with the DMS generating and sending an inactivity message to the sending user agent as in a typical out of office auto-reply. In response to determining that delivery control is current enabled, the DMS may implement a default access control on the retrieved email that restricts access by the receiving user agent.

At block 412, the DMS determines whether or not the received email is a thread email that contains email content of another email that has already been received during the inactivity period. For example, the received email may be a thread email generated and sent by a second sender MUA that contains content of an email generated and sourced from a first sender MUA and received during the inactivity period. The determination that the currently received email is an email thread source from a different sender MUA than the MUA that sourced the original email the content of which is included in the current email may be made by comparing header information of the current and previously received emails.

At block 414, in response to determining that the currently received email is a thread email generated by a different sender MUA than the MUA that sourced the original email, the DMS generates and sends a thread update request message to the original sender (i.e., the MUA that generated the email content contained in the current, differently sourced email). In some embodiments, the thread update request message associates an ID of the previously received email in the thread (e.g., the original email in the thread) with one or more delivery pendency options including at least a delivery termination option. As shown at blocks 416 and 418, in response to receiving a reply to the thread update request that includes selection of the delivery termination option, the DMS generates and sends to the MUA that generated the currently received email a thread update message. In some embodiments, the thread update message includes message text or other means of indication that the delivery of the previously received email has been terminated.

At block 420, the DMS retrieves delivery control settings for the receiving user agent to determine current delivery pendency options. The DMS includes the current delivery pendency options within a pending delivery request that is generated and sent to the sending user agent at block 422. Based on a reply to the pending delivery request from the sending user agent, the DMS modifies the default access control based on the delivery pendency options selected in the reply (block 424). The cycle of processing incoming emails for the receiving user agent at blocks 406 through block 424 is repeated until the DMS detects that the inactivity period has expired at block 426.

In response to detecting that the inactivity period has expired, the DMS retrieves delivery completion control settings for the receiving user agent (block 428). The retrieved settings may include multiple delivery completion options that are incorporated into a delivery completion request that is generated and sent to the sending user agent at block 430. The process concludes at block 432 with the DMS terminating delivery or otherwise modifying access control of received emails based on delivery options selected in a reply to the delivery completion request.

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality provided as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

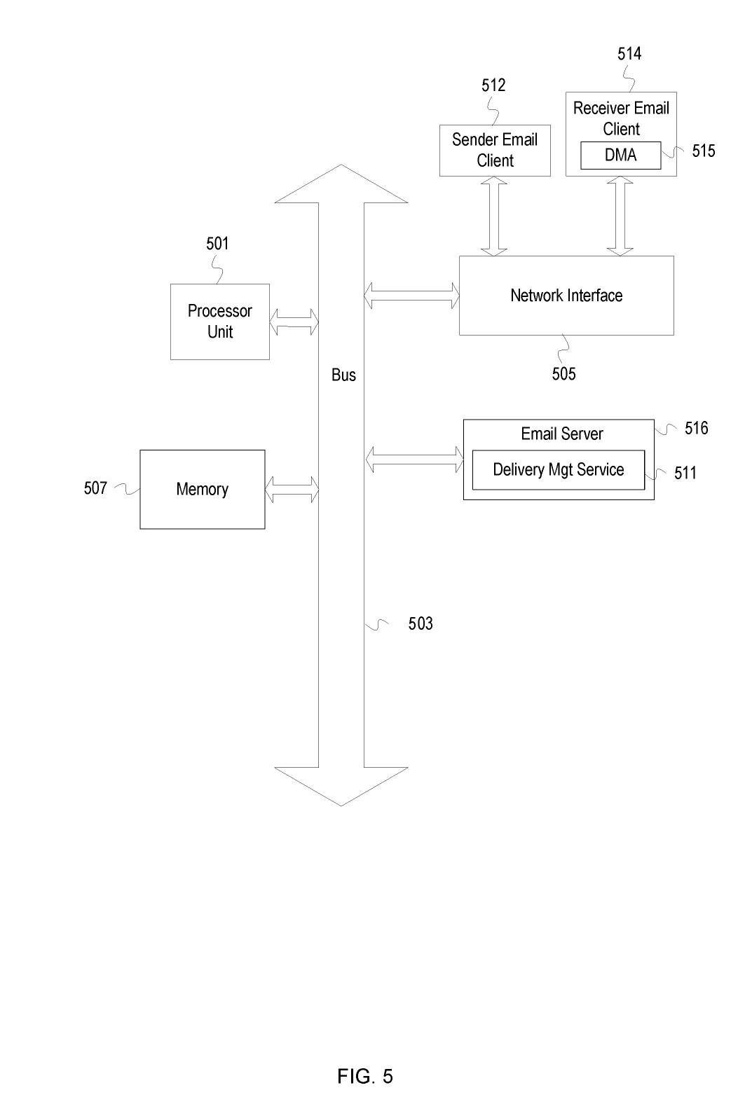

FIG. 5 depicts an example computer system for implementing multi-lateral accumulated email processing in accordance with some embodiments. The computer system includes a processor unit 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport® bus, InfiniBand® bus, NuBus, etc.) and a network interface 505 (e.g., a Fiber Channel interface, an Ethernet interface, an internet small computer system interface, SONET interface, wireless interface, etc.).

The system includes email clients 512 and 514 that are communicatively coupled to an email server 516. Email client 514 includes a delivery management agent 515 for determining control settings for a delivery management service 511 within email server 516. Delivery management agent 515, delivery management service 511 and email server 516 may incorporate the systems, devices, and components depicted and described with reference to FIGS. 1-4. Delivery management agent 515, delivery management service 511 include and provide program and data structures for implementing multi-lateral control of distribution and pendency of emails as depicted and described with reference to FIGS. 1-4. To this end, email client 514 and email server 516 may incorporate and/or utilize some or all of the system, devices, components, and data structures described in FIGS. 1-4.

Any one of the previously described functionalities may be partially (or entirely) implemented in hardware and/or on the processor unit 501. For example, the functionality may be implemented with an application specific integrated circuit, in logic implemented in the processor unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501 and the network interface 505 are coupled to the bus 503. Although illustrated as being coupled to the bus 503, the memory 507 may be coupled to the processor unit 501.

While the aspects of the disclosure are described with reference to various implementations and exploitations, it will be understood that these aspects are illustrative and that the scope of the claims is not limited to them. In general, techniques for multi-lateral pendency and distribution of accumulated emails as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality shown as separate components in the example configurations may be implemented as a combined structure or component. Similarly, structures and functionality shown as a single component may be implemented as separate components. These and other variations, modifications, additions, and improvements may fall within the scope of the disclosure.

As used herein, the term “or” is inclusive unless otherwise explicitly noted. Thus, the phrase “at least one of A, B, or C” is satisfied by any element from the set {A, B, C} or any combination thereof, including multiples of any element.

What is claimed is:

1. A method for email delivery processing, said method comprising:
detecting an inactivity indicator associated with a first email agent;
based on detecting the inactivity indicator, generating and sending a delivery completion request to a second email agent from which a first email is received prior to said detecting the inactivity indicator, wherein the delivery completion request includes one or more selectable delivery options including at least a delivery termination option; and
based on a reply from the second email agent to the delivery completion request that includes selection of the delivery termination option, terminating delivery of the first email to the first email agent.

2. The method of claim 1, wherein the first email agent is associated with an email inbox in which incoming emails are recorded, said detecting an inactivity indicator comprising:
detecting, for the first email recorded in the email inbox, a period over which the first email remains unopened by a user interface of the first email agent; and
determining, for the first email, that the period exceeds a specified threshold period.

3. The method of claim 1, further comprising:
detecting an inactivity period indicator from the first email agent; and
based on the inactivity period indicator and in response to receiving the first email addressed to the first email agent from the second email agent, implementing a visibility control on the first email.

4. The method of claim 3, wherein said implementing a visibility control comprises implementing an access control on the first email that restricts access by the first email agent to the first email.

5. The method of claim 4, wherein said implementing an access control on the first email includes storing the first email within a pending delivery container that includes an access table that associates the second email agent with the first email.

6. The method of claim 5, wherein said implementing an access control on the first email includes:
storing the first email as an email object; and
setting an access control code for a record within the access table that associates an identifier of the email object with an identifier of the second email agent.

7. The method of claim 3, wherein said detecting an inactivity period indicator comprises detecting an auto-reply instruction from the first email agent that specifies an inactivity period having a start time point and an end time point, and wherein said detecting an inactivity indicator comprises detecting expiration of the end time point.

8. The method of claim 7, wherein said implementing the visibility control is performed in further response to receiving the first email after the start time point and prior to the end time point.

9. The method of claim 3, further comprising:
in response to receiving a second email from a third email agent following detecting the inactivity period indicator and prior to detecting the inactivity indicator,
comparing header information of the second email with header information of the first email to determine whether the second email is an email thread message that includes the content of the first email; and
in response to determining that the second email is an email thread message that includes content of the first email, generating and sending a thread update request to the second email agent, wherein the thread update request associates an identifier of the first email with one or more delivery pendency options including at least a delivery termination option.

10. The method of claim 9, further comprising:
in response to receiving a reply message from the second email agent to the thread update request that includes selection of the delivery termination option, generating and sending a thread update message to the third email agent that indicates the selection by the first email agent of the delivery termination option.

11. The method of claim 3, further comprising, based on the inactivity period indicator and in response to receiving the first email, generating and sending a pending delivery request to the second email agent, wherein the pending delivery request includes one or more delivery pendency options including at least an alternate delivery option that specifies another email agent.

12. The method of claim 11, wherein one of the delivery pendency options comprises a pendency override option, said method further comprising removing the visibility control in response to receiving a reply message from the second email agent to the pending delivery request that includes selection of the pendency override option.

13. One or more non-transitory machine-readable media comprising program code for email delivery processing, the program code to:
detect an inactivity indicator associated with a first email agent;
based on detecting the inactivity indicator, generate and send a delivery completion request to a second email agent from which a first email is received prior to said detecting the inactivity indicator, wherein the delivery completion request includes one or more selectable delivery options including at least a delivery termination option; and
based on a reply from the second email agent to the delivery completion request that includes selection of the delivery termination option, terminate delivery of the first email to the first email agent.

14. The machine-readable media of claim 13, wherein the program code includes program code to:
detect an inactivity period indicator from the first email agent; and
based on the inactivity period indicator and in response to receiving the first email addressed to the first email agent from the second email agent, implement an access control on the first email that restricts access by the first email agent to the first email.

15. The machine-readable media of claim 14, wherein the program code to detect an inactivity period indicator comprises program code to detect an auto-reply instruction from the first email agent that specifies an inactivity period having a start time point and an end time point, wherein the program code to detect an inactivity indicator comprises program code to detect expiration of the end time point, and wherein said implementing the access control is performed in further response to receiving the first email after the start time point and prior to the end time point.

16. The machine-readable media of claim 14, wherein the program code includes program code to, based on the inactivity period indicator and in response to receiving the first email, generate and send a pending delivery request to the second email agent, wherein the pending delivery request includes one or more delivery pendency options including at least an alternate delivery option that specifies another email agent.

17. An apparatus comprising:
a processor; and
a machine-readable medium having program code executable by the processor to cause the apparatus to:
detect an inactivity indicator associated with a first email agent;
based on detecting the inactivity indicator, generate and send a delivery completion request to a second email agent from which a first email is received prior to said detecting the inactivity indicator, wherein the delivery completion request includes one or more selectable delivery options including at least a delivery termination option; and
based on a reply from the second email agent to the delivery completion request that includes selection of the delivery termination option, terminate delivery of the first email to the first email agent.

18. The apparatus of claim 17, wherein the program code includes program code executable by the processor to cause the apparatus to:
detect an inactivity period indicator from the first email agent; and
based on the inactivity period indicator and in response to receiving the first email addressed to the first email agent from the second email agent, implement an access control on the first email that restricts access by the first email agent to the first email.

19. The apparatus of claim 18, wherein the program code comprises program code executable by the processor to cause the apparatus to:
detect an auto-reply instruction from the first email agent that specifies an inactivity period having a start time point and an end time point; and
detect expiration of the end time point, and wherein said implementing the access control is performed in further response to receiving the first email after the start time point and prior to the end time point.

20. The apparatus of claim 18, wherein the program code includes program code executable by the processor to cause the apparatus to, based on the inactivity period indicator and in response to receiving the first email, generate and send a pending delivery request to the second email agent, wherein the pending delivery request includes one or more delivery pendency options including at least an alternate delivery option that specifies another email agent.
